(19) United States
(12) Patent Application Publication
(10) Pub. No.: US 2024/0227004 A1
(43) Pub. Date: Jul. 11, 2024

(54) METHOD FOR MANUFACTURING A FAN DISK WITH A PART BY ADDITIVE MANUFACTURING

(71) Applicant: SAFRAN AIRCRAFT ENGINES, PARIS (FR)

(72) Inventors: Alexandre Michel Henri HASQUENOPH, MOISSY CRAMAYEL (FR); Hamza GUESSINE, MOISSY CRAMAYEL (FR); Jeremy SMITH, MOISSY CRAMAYEL (FR); Antonin VIGOURT, MOISSY CRAMAYEL (FR)

(21) Appl. No.: 18/550,395

(22) PCT Filed: Mar. 11, 2022
(86) PCT No.: PCT/FR2022/050451

§ 371 Date: Sep. 13, 2023

(30) Foreign Application Priority Data
Mar. 16, 2021 (FR) 2102574

(51) Int. Cl. B22F 3/17; B22F 5/00; B33Y 10/00

(52) U.S. Cl. CPC B22F 3/17; B33Y 10/00; B22F 2005/005; B22F 2998/10

(57) ABSTRACT

A method for manufacturing a fan disk of a turbine engine includes forging a first cylindrical shape of axis X, machining the first cylindrical shape to obtain a second cylindrical shape, adding by additive manufacturing at least one relief clement to the second cylindrical shape.

### TECHNICAL FIELD OF THE INVENTION

The technical field of the invention is that of aeronautical turbine engines, in particular turbine engines with a very high dilution rate and more particularly the fan disk equipping said engines.

### TECHNOLOGICAL BACKGROUND OF THE INVENTION

The fan disk is located in the upstream part of the turbine engine and carries the blades. Its main function is to transmit the torque from the low pressure compressor shaft to the blades.

The blades are fitted on the periphery of the disk by engaging the blade roots in cells formed at the periphery of the disk in the form of grooves for radial retaining of the blade roots. This disk is described in particular in documents EP 1 400 698, FR 3 081 520, FR 3 048 997. It comprises a plurality of substantially axial grooves uniformly distributed angularly and intended to receive a plurality of removable blades which extend radially outwards to the periphery of said disk, each blade comprising a blade root housed in a groove. It also has several protruding holed studs on its rear periphery which complete the attachment of the blades. Two relief inner ferrules are also provided at the front and rear for the front attachment of the blades and for the attachment of the fan disk to the transmission shaft. These different elements must be machined from a blank.

The fan is subjected to high stresses, therefore materials with improved properties must be used, which are obtained by a method of forging.

Current manufacturing methods use conventional manufacturing means (milling machine, lathe, etc.) to produce the fan disk. These methods require pre-machining as well as a large blank that encompasses the entire part, i.e. the blank has an envelope that covers all the roughnesses of the finished part. Pre-machined parts are heavy and expensive because they are of large size, they require an extended machining cycle and high chip loss, resulting in a substantial amount of wasted material and a high manufacturing cost.

### SUMMARY OF THE INVENTION

The invention offers a solution to the problems mentioned above, by significantly reducing the size of the blank and of the pre-machine part, by reducing the costs of obtaining the blank and pre-machined part which are simpler in shape while offering both the possibility of changing the material and, potentially, gaining mass on the finished part, and making new forms that cannot be manufactured with conventional means for secondary functions.

The purpose of the invention is to make the disk partially by additive manufacturing.

The method for manufacturing a fan disk of a turbine engine according to the invention is characterized in that it comprises the following steps:
a step of forging a first cylindrical shape of axis X,
a step of machining the first cylindrical shape to obtain a second cylindrical shape,
a step of adding by additive manufacturing at least one relief element to the second cylindrical shape.

The first cylindrical shape is a simplified blank that encompasses the main parts of the disk without the different relief parts, especially those of small size, such as studs and ferrules, and is therefore smaller and simpler in shape than the state-of-the-art blank. It is therefore lighter and less bulky, therefore cheaper.

The second cylindrical shape made from the first cylindrical shape is a semi-finished part which does not comprise the relief elements. It is also lighter and less cumbersome. The part is cheaper because not only is there less material, but less material is lost during machining.

The different relief elements are added by additive manufacturing in the zones which have been simplified. But relief elements can be placed where desired and have new shapes that cannot be achieved with conventional means. The simplified zones, which may correspond to constraint functions not requiring the same material characteristics as the main body, are added by an additive manufacturing process using the same or another material with properties more interesting in respect of needs (lower density, better traction strength, etc.).

In addition to the characteristics that have just been mentioned in the preceding paragraph, the method according to the invention can have one or more additional characteristics from the following, considered individually or according to any technically permissible combination.

Advantageously, the second cylindrical shape has an outer face and an inner face, and the relief element is located on the outer face of the second cylindrical shape. The relief element is added by additive manufacturing on the outer face of the second cylindrical shape, there may be one or more, they may be continuous or discontinuous.

Advantageously, the second cylindrical shape has an outer face and an inner face and the relief element is located on the inner face of the second cylindrical shape. The relief element is added by additive manufacturing on the inner face of the second cylindrical shape, there may be one or more, they may be continuous or discontinuous

Advantageously, the relief element is circular of axis X. It may be located inside or outside the second cylindrical shape, at the front or at the rear of the latter. It may comprise attachment elements and therefore be perforated. This element can, for example, constitute a ferrule.

Advantageously, the relief element is a stud. The stud is projecting and of semicircular shape connected to the second cylindrical shape.

Advantageously, the stud is drilled along an axis X′. The hole is used to attach the blade and it can also be tapped.

Advantageously, the axis X′ is parallel to the axis X.

Advantageously, several studs are added to the outside of the second cylindrical shape. Preferably, there will be at least as many studs as blades.

Advantageously, the studs are arranged circularly on the second shape. The studs will, for example, enable the rear attachment of each blade.

The invention also relates to a fan disk obtained by the method according to at least one of the preceding characteristics.

### BRIEF DESCRIPTION OF THE FIGURES

The figures are presented for the purposes of information and in no way limit the invention.

FIG. 1 is a cross-section of the front of a turbine engine with a state-of-the-art fan disk;

FIG. 2 shows the detail II-II of FIG. 1 showing the blank and the finished part made with a state-of-the-art method;

FIG. 3 is a perspective view of another fan disk of the state of the art;

FIG. 4 is a cross-section of a part of the fan of FIG. 3 showing the blank part and the finished part made with a state-of-the-art method;

FIG. 5 is a cross-section of the part of FIG. 1 showing the blank part and the finished part made with a method according to the invention;

FIG. 6 is a cross-section of the part of FIG. 4 showing the blank part and the finished part made with a method according to the invention

FIG. 7 shows the steps of the method according to the invention.

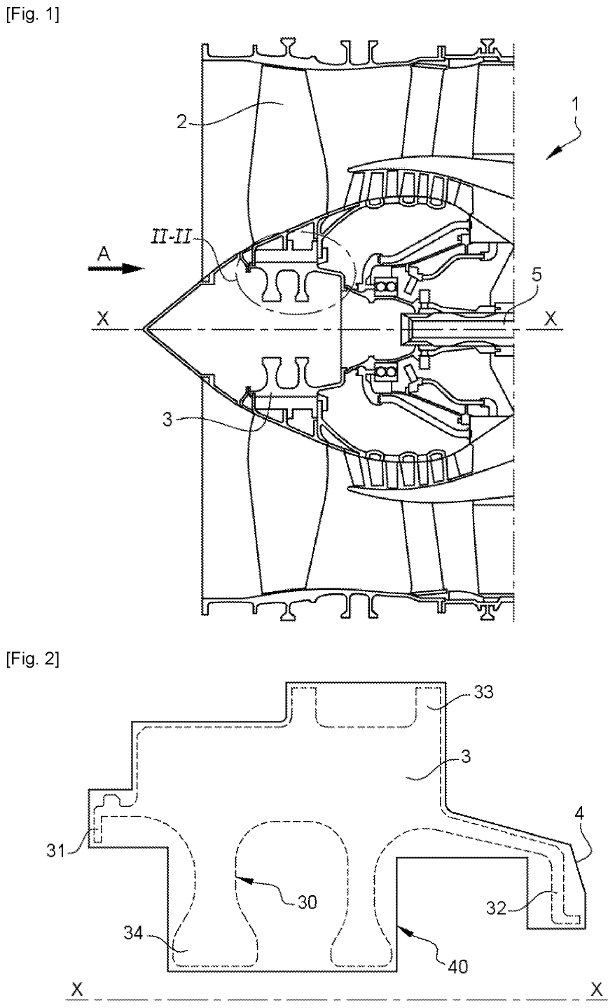

### DETAILED DESCRIPTION

The figures are presented for the purposes of information and in no way limit the invention.

Unless otherwise specified, the same element appearing in different figures

has a unique reference.

Throughout the description, the upstream part of the turbine engine will be referred to as “front” in the direction of air flow according the arrow A and “rear” as the downstream part. The term “inner” will refer to the part located towards the inside of the cylindrical part and “outer” on the outer part.

The turbine engine 1 comprises blades 2 and a fan disk 3 on which the blades 2 are arranged. The turbine engine 1 and fan disk 3 have a common axis X. The fan disk 3 is hollow and of cylindrical shape.

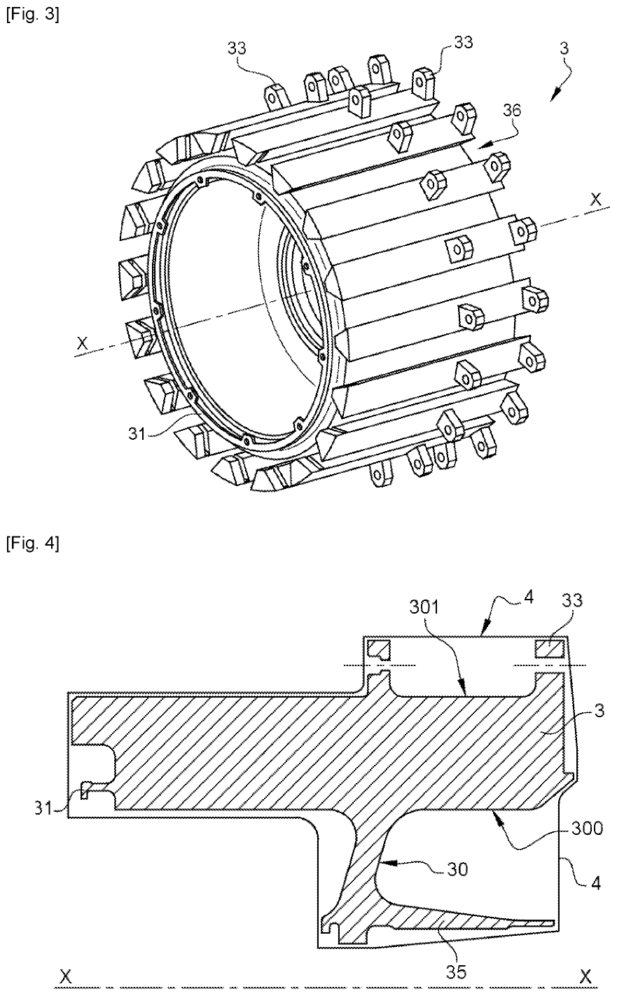

Another example of a disk is shown in perspective in FIG. 3, which shows that this disk has a very complex shape and has a substantial number of roughnesses both outside, inside, at the front and at the rear.

For better understanding, only one side of the cross-section of the fan disk 3 is shown in FIGS. 2, 4, 5 and 6, the axis X being a symmetry axis.

In the cross-section of FIG. 2, the shape of the blank 4 is represented by the solid line while the profile of the fan disk 3 is dotted. The outer surface of the fan disk 3 comprises studs 33 and the front part comprises a front ferrule 31 and the rear part comprises a rear ferrule 32, as well as feet 34 inside. The studs 33 and the front ferrule 31 are used to attach the blades 2, while the rear ferrule 32 is attached to the shaft 5. All these relief elements must be contained in the blank 4 to obtain a one-piece part capable of meeting the different stresses that the blades 2 are subjected to.

The carrying out of the fan disk 3 from the blank 4 according to the state of the art is as follows:
making a blank 4 of annular shape by forging enclosing roughly the entire final part and,
machining the blank 4 from the outside to precisely carry out external roughnesses such as studs 33, but also grooves 36 on the outer surface 301,
machining of the blank 4 from the inside to precisely carry out internal roughnesses such as the feet 34 on the inner surface 300,
machining of the blank 4 from the front and rear to precisely carry out the front asperities such as the front ferrule 31 and rear such as the rear ferrule 32.

It is understood that as the blank 4 cannot have a shape that is complex or excessively cut, it must always be machined to respect the dimensions and shapes necessary to produce the final part. Indeed, the final part must meet certain tolerances that are incompatible with forged parts. The cutting of the fan disk 3 and the quantity of roughnesses that it has increases the length and complexity of the maching steps.

Thus, as can be seen in the example shown in FIG. 2, the blank 4 is delimited by a thick line representing a first cylindrical shape 40 while the final part is delimited by a dotted line 30. The gap between the two lines represents all the material lost by machining which is substantial. We can also see the complexity of the shapes to be produced by machining, more particularly the thin parts such as the studs 33 perforated along an axis X′, and the front 31 and rear 32 ferrules, the latter having in addition particularly complicated profiles to develop.

In the second example of FIGS. 3 and 4, the profile of the fan disk 3 is different in its inner part and in its rear part. Thus the fan disk 3 has studs 33 perforated along an axis X′, a front ferrule 31 and an inner arm 35 for attaching the fan disk 3 to the shaft 5. This inner arm 35 forms a U with the inner surface 300 of the fan disk 3. But the method of manufacturing is identical.

In FIG. 4, the blank 4 is delimited by a solid line representing a first cylindrical shape 40 and the fan disk 3 by a solid line 30 with the interior hatched. The difference between the lines shows the material lost by machining, which is also substantial. Here again, the shapes to be produced are highly cut and complex to produce by machining. In particular, the studs 33 are first formed externally by a first machining, then they are perforated along an axis X′, then possibly tapped by a second machining.

With the method according to the invention, the fan disks 3 are made differently, since it consists of using three different techniques: forging, machining, and additive manufacturing.

The first step indicated by the reference FO in FIG. 7, is a forging step of a poorly developed blank 6 having a simple profile in a first cylindrical shape smaller than that of the known method.

The second step consists of a machining operation referenced U in FIG. 7, this step U makes it possible to make the general shape of the fan disk 3 without its roughnesses into a second cylindrical shape. This step U is simpler than that of the state of the art as there are fewer shapes to be produced by machining and they are less complex.

The third step referenced FA in FIG. 7 makes it possible to make all the missing roughnesses to obtain the final shape of the fan disk 3. These roughnesses can have more complex shapes than those produced by simple machining as in the method of the state-of-the-art.

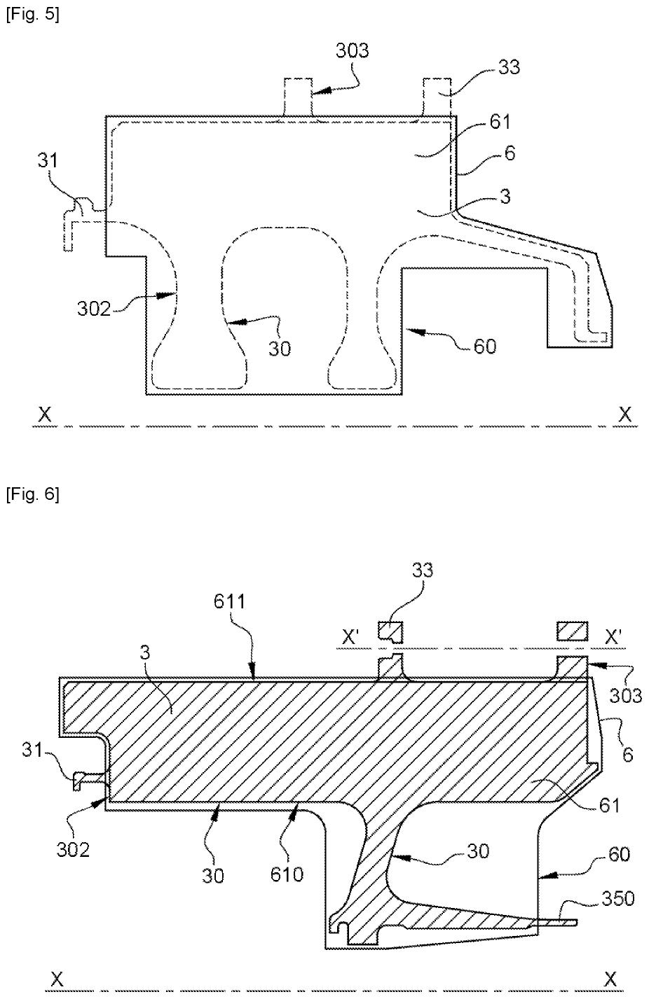

Thus, as can be seen in the example shown in FIG. 5, the blank 6 is delimited by a thick line representing a first cylindrical shape 60 while the final part is delimited by a dotted line 30. It can be seen that the final shape represented by the dotted line 30 is broken down into two parts: a first part 302 arranged inside the first cylindrical shape 60 and a second part 303 arranged outside the first cylindrical shape 60. The gap between the first line 302 and the first cylindrical shape 60 represents all the material lost by machining which is less than that in FIG. 2.

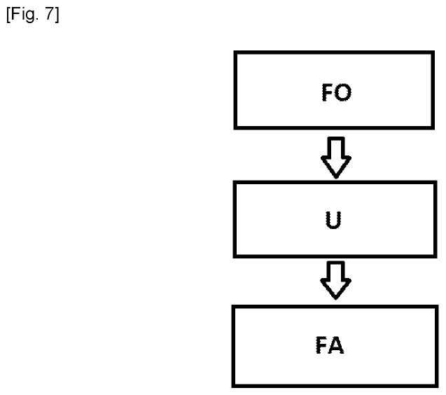

In FIG. 4, the blank 4 is delimited by a solid line representing a first cylindrical shape 60 and the fan disk 3 by a solid line 30 with the interior hatched. It can be seen that the final shape represented by the solid line 30 is broken down into two parts: a first part 302 arranged inside the first cylindrical shape 60 and a second part 303 arranged outside the first cylindrical shape 60. The gap between the line 302 and the first cylindrical shape 60 shows the material lost by machining, which is also smaller than that in FIG. 6.

The forging step FO therefore consists in producing the blank 6 according to a first cylindrical shape 60.

The machining step U consists in removing the material between the cylindrical shape 60 and the first part 302 of the line 30, in order to make a second cylindrical shape 61.

The last step FA of additive manufacturing makes it possible to carry out all the roughnesses not contained in the second cylindrical shape 61. This second cylindrical shape 61 has an inner face 610 and an outer face 611.

Thus, for the shape of the fan disk 3 shown in FIG. 5, the forging is in the form of the blank 6 enclosing only a part of the final part, indeed the first cylindrical shape 60 does not encompass the protruding parts such as the studs 33 and the front ferrule 31. Once the blank 6 has been machined, a second cylindrical shape 61 is obtained, delimited by the dotted line 302. On this second cylindrical shape 61, the studs 33 and the front ferrule 31 are added by additive manufacturing up to the line 303.

For the example in FIG. 6, in the same way, a blank 6 is made by forging, this blank forming a first cylindrical shape 60 does not encompass the studs 33, the front ferrule 31, or the end 350 of the arm 35. Then, machining is carried out that makes it possible to obtain the second cylindrical shape 61 delimited by the hatched part and the line 302. The projecting parts are then produced by additive manufacturing up to line 303.

Two examples of the fan disk were shown, but it is possible, by the method according to the invention, to carry out more protruding shapes and of shapes different from those shown.

1. A method for manufacturing a fan disk of a turbine engine, comprising the following steps:
forging a first cylindrical shape of axis X,
machining the first cylindrical shape to obtain a second cylindrical shape,
adding by additive manufacturing at least one relief element on the second cylindrical shape,
wherein the second cylindrical shape has an outer face and an inner face and the relief element is located on the inner face of the second cylindrical shape.

2. The method according to claim 1, wherein the second cylindrical shape has an outer face and an inner face and the relief element is located on the outer face of the second cylindrical shape.

3. The method according to claim 1, wherein the relief element is circular of axis X.

4. The method according to claim 1, wherein the relief element is a stud.

5. The method according to claim 4, wherein the stud is drilled along an axis X′.

6. The method according to claim 5, wherein the axis X′ is parallel to the X axis.

7. The method according to claim 4, wherein several studs are added to the outside of the second cylindrical shape.

8. The method according to claim 7, wherein the studs are arranged circularly on the second cylindrical shape.

9. A fan disk obtained by the method according to claim 1.
